(19) United States
(12) Patent Application Publication
(10) Pub. No.: US 2025/0332994 A1
(43) Pub. Date: Oct. 30, 2025

(54) EXTERNAL REAR-VIEW MIRROR MOUNTING STRUCTURE

(71) Applicant: Guangzhou Issyzone Technology Co.,Limited, Guangzhou (CN)

(72) Inventors: Taiping Yang, Guangzhou City (CN); Ning Wang, Guangzhou City (CN); Guoyuan Lin, Guangzhou City (CN)

(21) Appl. No.: 19/087,593

(22) Filed: Mar. 24, 2025

(30) Foreign Application Priority Data
Apr. 29, 2024 (CN) 2024209206831

(51) Int. Cl. B60R 1/076; B60R 1/12

(52) U.S. Cl. CPC B60R 1/076; B60R 1/1207

(57) ABSTRACT

Disclosed in the present disclosure is an external rear-view mirror mounting structure, including an external rear-view mirror, in which the external rear-view mirror includes: a housing; a mirror, removably mounted on a front side of the housing; and a connecting member, in which a rear side of the housing is provided with a mounting groove with hemispherical shape, an end of the connecting member is provided with a hemispherical joint fitted with the mounting groove, and an opposite end of the connecting member is provided with a connecting arm kit configured to fix with a target vehicle. The beneficial effect of the utility model is that the user only needs to replace the connecting arm kit including the hemispherical joint by providing a mounting groove at a back side of the external rear-view mirror, without the necessity of replacing the external rear-view mirror, which saves the user's usage costs.

### CROSS REFERENCE TO RELATED APPLICATIONS

The present application claims the priority of Chinese patent application No. 2024209206831, filed on Apr. 29, 2024, and contents of which are incorporated herein by reference.

### TECHNICAL FIELD

The present disclosure relates to the technical field of automobile accessories, and in particular, to an external rear-view mirror mounting structure.

### BACKGROUND

An off-road vehicle is an automobile specially designed for off-roading. Users often upgrade and modify it in order to enhance its off-road performance. Replacing the external rear-view mirrors is a common form of off-road appearance modification. The original rear-view mirrors of off-road vehicles are mounted on the screw holes of the A-pillar. Therefore, car accessory manufacturers have to design new fixing members according to the screw holes of the original vehicle for each type of vehicle, so as to fix the external rear-view mirrors to the vehicle, resulting in each external rear-view mirror also requiring a redesign of the fixing holes to attach the aforementioned fixing members, and the user will need to repurchase an external rear-view mirror.

### SUMMARY

In view of the above problems, proposed in the present disclosure is an external rear-view mirror mounting structure, which mainly addresses the problem that there is no universal connecting structure between the existing external rear-view mirror and the fixing member.

In order to address the above technical problems, the technical solution of the present disclosure is as follows:

An external rear-view mirror mounting structure, including an external rear-view mirror. The external rear-view mirror includes: a housing; a mirror, removably mounted on a front side of the housing; and a connecting member, in which a rear side of the housing is provided with a mounting groove with hemispherical shape, an end of the connecting member is provided with a hemispherical joint fitted with the mounting groove, and an opposite end of the connecting member is provided with a connecting arm kit configured to fix with a target vehicle.

In some implementations, a side of the connecting member is provided with a first fixing groove, an opposite side of the connecting member is provided with a second fixing groove, a first smooth hole is provided between the first fixing groove and the second fixing groove, a middle of the hemispherical joint is provided with a second smooth hole, a middle of the mounting groove is provided with a third smooth hole, a spherical portion of the hemispherical joint is inserted into the mounting groove, a flat portion of the hemispherical joint is inserted into the second fixing groove, a fastener is inserted from the first fixing groove, sequentially passes through the first smooth hole, the second smooth hole, and the third smooth hole, and finally enters the housing to be in a fixed connection with a corresponding locking member.

In some implementations, the external rear-view mirror mounting structure further includes a thrust bearing, and the thrust bearing is provided between the second fixing groove and the flat portion of the hemispherical joint.

In some implementations, an inner side of the housing is provided with a third fixing groove, the third smooth hole is located at a center of the third fixing groove, and the locking member is mounted in the third fixing groove.

In some implementations, the fastener is a bolt, and the locking member is a nut.

In some implementations, a back side of the housing is provided with a light transmitting groove, and a light strip is provided in an interior of the housing.

In some implementations, the connecting arm kit includes a rotating arm hinged to the connecting member and a block-shaped fixing member hinged to the rotating arm. The rotating arm has at least two rotational degrees of freedom. A fixing column is disposed on a side of the fixing member; an axial center of the fixing column is provided with a mounting hole configured to fix with a target vehicle. The mounting hole penetrates through the entire fixing member; an insertion port is formed at an opposite side of the fixing member. The connecting arm kit further includes a ball joint and a threaded extension stud mounted at an end of the ball joint. A middle of the threaded extension stud is provided with a limit collar, and the threaded extension stud is screwed into the mounting hole through the insertion port.

In some implementations, the connecting arm kit includes a rotating arm hinged to the connecting member and a fixing member hinged to the rotating arm, in which the rotating arm has at least two rotational degrees of freedom, the fixing member is configured as a right triangle, and a center of the fixing member is provided with a mounting hole configured to fix with a target vehicle.

The beneficial effect of the utility model is that the user only needs to replace the connecting arm kit including the hemispherical joint by providing a mounting groove at a back side of the external rear-view mirror, and the external rear-view mirror is assembled with the connecting member by means of the mounting groove, without the necessity of replacing the external rear-view mirror, which saves the user's usage costs.

### BRIEF DESCRIPTION OF THE DRAWINGS

FIG. 1 is a perspective view of an external rear-view mirror mounting structure disclosed in embodiments of the present disclosure;

FIG. 2 is a first exploded view of the external rear-view mirror mounting structure disclosed in the embodiments of the present disclosure;

FIG. 3 is a second exploded view of the external rear-view mirror mounting structure disclosed in the embodiments of the present disclosure;

FIG. 4 is a schematic diagram of a connecting arm kit disclosed in the embodiments of the present disclosure; and

FIG. 5 is a schematic diagram of another connecting arm kit disclosed in the embodiments of the present disclosure.

Labels: 1, external rear-view mirror; 2, connecting member; 3, connecting arm kit; 101, housing; 102, mirror; 103, mounting groove; 104, third fixing groove; 105, light transmitting groove; 201, hemispherical joint; 202, first fixing groove; 203, second fixing groove; 204, first smooth hole; 205, second smooth hole; 206, third smooth hole; 207, fastener; 208, locking member; 209, thrust bearing; 301, rotating arm; 302, fixing member; 303, fixing column; 304, mounting hole; 305, insertion port; 306, spherical joint; 307, threaded extension stud; 308, limit collar.

### DETAILED DESCRIPTION

In order to enable the purpose, technical solution and advantages of the present disclosure to be clearer and more explicit, the contents of the present disclosure are described in further detail below in connection with the attached drawings and specific embodiments. It is to be understood that the specific embodiments described herein are only for the purpose of explaining the present disclosure and are not a limitation of the present disclosure. It should also be noted that, for ease of description, only some, but not all, of the elements relevant to the present disclosure are shown in the attached drawings.

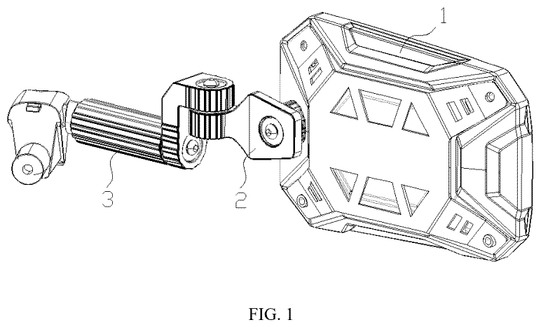

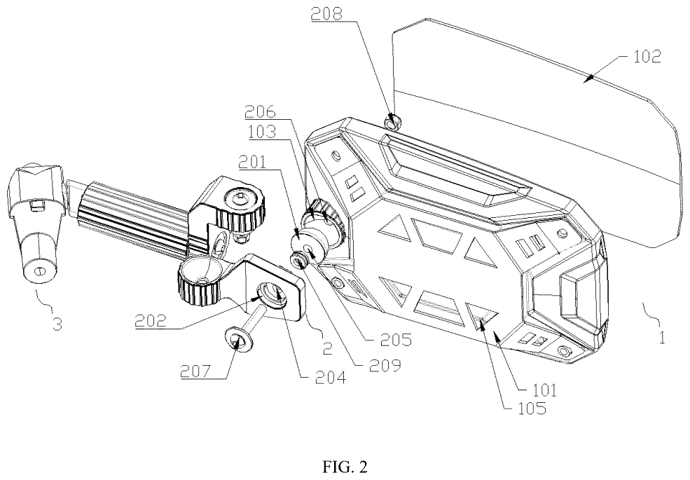

Proposed in the present embodiment is an external rear-view mirror mounting structure, as shown in FIGS. 1 and 2, including an external rear-view mirror 1. The external rear-view mirror 1 includes a housing 101; a mirror 102 removably mounted on a front side of the housing 101; and a connecting member 2, in which a rear side of the housing 101 is provided with a mounting groove 103 with hemispherical shape, an end of the connecting member 2 is provided with a hemispherical joint 201 fitted with the mounting groove 103, and an opposite end of the connecting member 2 is provided with a connecting arm kit 3 configured to fix with a target vehicle.

According to the present embodiment, the user only needs to replace the connecting arm kit 3 including the hemispherical joint 201 by providing a mounting groove 103 at a back side of the external rear-view mirror 1, and the external rear-view mirror 1 is assembled with the connecting member 2 by means of the mounting groove 103, without the necessity of replacing the external rear-view mirror 1, which saves the user's usage costs. Similarly, manufacturers may design different connecting arm kits 3 based on the mounting groove 103 and hemispherical joint 201 described above, reducing research and development expenditures.

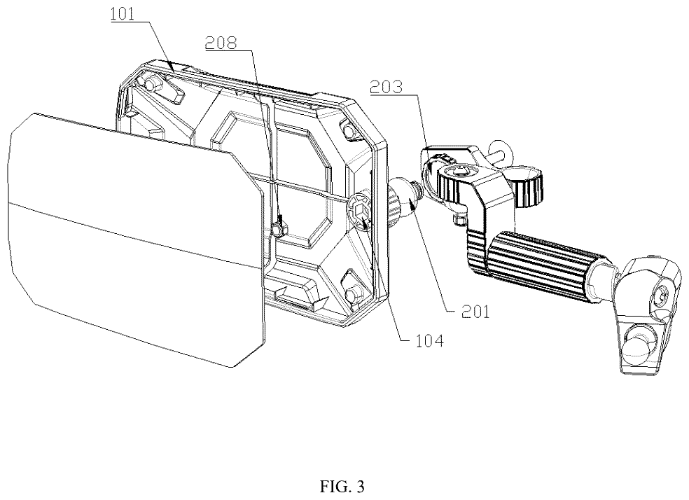

In the present embodiment, the aforementioned connecting structure between the mounting groove 103 and the hemispherical joint 201 may be diversified, and it is sufficient to enable a stable connection between the external rear-view mirror 1 and the connecting member 2. In an example, as shown in FIGS. 2 and 3, a side of the connecting member 2 is provided with a first fixing groove 202, an opposite side of the connecting member 2 is provided with a second fixing groove 203, a first smooth hole 204 is provided between the first fixing groove 202 and the second fixing groove 203, a middle of the hemispherical joint 201 is provided with a second smooth hole 205, a middle of the mounting groove 103 is provided with a third smooth hole 206, a spherical portion of the hemispherical joint 201 is inserted into the mounting groove 103, a flat portion of the hemispherical joint 201 is inserted into the second fixing groove 203, a fastener 207 is inserted from the first fixing groove 202, sequentially passes through the first smooth hole 204, the second smooth hole 205, and the third smooth hole 206, and finally enters the housing 101 to be in a fixed connection with a corresponding locking member 208. In this example, the first fixing groove 202 serves to accommodate an end of the fastener 207, indicating the installation depth of the fastener 207 during installation, the second fixing groove 203 serves to accommodate a flat portion of the hemispherical joint 201, and the mounting groove 103 serves to accommodate a spherical portion of the hemispherical joint 201. Finally, the fastener 207 passing through the coaxially provided first smooth hole 204, second smooth hole 205, and third smooth hole 206 enters the housing 101 to form an effective fixation with the corresponding locking member 208. Assuming that the connecting member 2 is fixed, when the user is rotating the external rear-view mirror 1, the fastener 207 and the locking member 208 are synchronized to rotate, while the hemispherical joint 201 provides relatively small sliding friction to avoid the external rear-view mirror 1 being difficult to rotate. It should be noted that, in this embodiment, the hemispherical joint 201 can only be rotated along a plane due to the design of the fastener 207.

Further, on the basis of the aforementioned solution, referring to FIG. 2, the external rear-view mirror mounting structure further includes a thrust bearing 209, and the thrust bearing 209 is provided between the second fixing groove 203 and the flat portion of the hemispherical joint 201. In the present solution, in order to further reduce the friction between the hemispherical joint 201 and the second fixing groove 203, a thrust bearing 209 is provided between the second fixing groove 203 and the flat portion of the hemispherical joint 201. Thrust bearings are specialized bearings used to withstand axial forces, that is, bearings that are specialized to withstand forces in the direction parallel to the shaft.

The aforementioned locking member 208 is provided in the housing 101. Specifically, a third fixing groove 104 is provided on an inner side of the housing 101, and as shown in the figure, a third smooth hole 206 is located at the center of the third fixing groove 104, and a bonding agent may be employed to install the locking member 208 in the third fixing groove 104. In an example, the fastener 207 is a bolt and the locking member 208 is a nut. After the bolt enters the third fixing groove 104 through the first smooth hole 204, the second smooth hole 205, and the third smooth hole 206 sequentially, the user can then screw the bolt into the nut by continuing screwing the bolt to secure the connecting member 2 to an outer side of the housing 101.

Optionally, referring further to FIG. 2, a rear side of the housing 101 is provided with a light transmitting groove 105, and an interior of the housing 101 is provided with a light strip (not shown in the figure) to increase the applicable scenarios of the product.

Different models need to be adapted with different connecting arm kits 3. The present embodiment illustrates the connection relationship between the connecting arm kit 3 and the connecting member 2 by showing the structure of two different connecting arm kits 3 as examples.

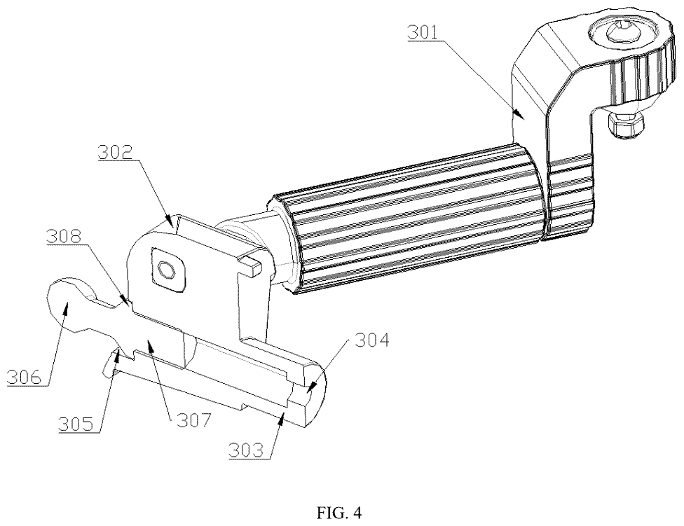

In an example, as shown in FIGS. 1 and 4, the connecting arm kit 3 includes a rotating arm 301 hinged to connecting member 2, and a block-shaped fixing member 302 hinged to the rotating arm 301. The rotating arm 301 has at least two rotational degrees of freedom. A fixing column 303 is disposed on a side of the fixing member 302, an axial center of the fixing column 303 is provided with a mounting hole 304 configured to fix with a target vehicle. The mounting hole 304 penetrates through the entire fixing member 302, an insertion port 305 is formed at an opposite side of the fixing member 302. The connecting arm kit 3 further includes a ball joint 306 and a threaded extension stud 307 mounted at an end of the ball joint 306. A middle of the threaded extension stud 307 is provided with a limit collar 308, and the threaded extension stud 307 is screwed into the mounting hole 304 through the insertion port 305. The aforementioned connecting arm kit 3, especially the portion of the fixing member 302, is specially adapted for Jeep 2018-2023 model year JL off-road vehicles. When in use, the fixing column 303 is first inserted into the original vehicle's mounting hole, then the threaded extension stud 307 is screwed into the mounting hole 304 from the insertion port 305 to complete fixing of the connecting arm kit 3, and the user can subsequently add a cell phone holder on his own through the spherical joint 306 and other accessories.

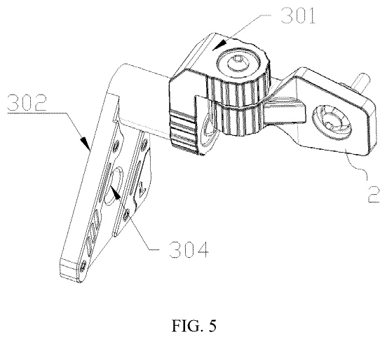

In another example, as shown in FIG. 5, the connecting arm kit 3 includes a rotating arm 301 hinged to the connecting member 2 and a fixing member 302 hinged to the rotating arm 301, in which the rotating arm 301 has at least two rotational degrees of freedom, the fixing member 302 is configured as a right triangle, and a center of the fixing member 302 is provided with a mounting hole 304 configured to fix with a target vehicle. The aforementioned connecting arm kit 3, in particular the portion of the fixing member 302, is specifically adapted for Jeep 2018-2024 model year JL off-road vehicles. When in use, the mounting hole 304 on the right triangle fixing member 302 is first abutted against the original mounting hole of the vehicle, and then secured by bolts.

The above embodiments are only intended to illustrate the technical concepts and features of the present disclosure, and are intended to enable persons of ordinary skill in the art to understand the contents of the present disclosure and to implement them accordingly, and are not intended to limit the scope of protection of the present disclosure. Any equivalent changes or modifications made in accordance with the substance of the contents of the present disclosure should be covered by the scope of protection of the present disclosure.

1. An external rear-view mirror mounting structure, comprising an external rear-view mirror, wherein the external rear-view mirror comprises:
a housing;
a mirror, removably mounted on a front side of the housing; and
a connecting member,
wherein an end of the connecting member is provided with a connecting arm kit configured to fix with a target vehicle, the connecting arm kit comprises:
a rotating arm, hinged to the connecting member;
a fixing member, hinged to the rotating arm, wherein the rotating arm has at least two rotational degrees of freedom, the fixing member is configured as a right triangle, a center of the fixing member is provided with a mounting hole configured to fix with the target vehicle, the mounting hole penetrates through the entire fixing member, and an insertion port is formed at a side of the fixing member;
a ball joint; and
a threaded extension stud, mounted at an end of the ball joint, wherein a middle of the threaded extension stud is provided with a limit collar, and the threaded extension stud is screwed into the mounting hole from the insertion port.

2. An external rear-view mirror mounting structure, comprising an external rear-view mirror, wherein the external rear-view mirror comprises:
a housing;
a mirror, removably mounted on a front side of the housing; and
a connecting member,
wherein a rear side of the housing is provided with a mounting groove with hemispherical shape, an end of the connecting member is provided with a hemispherical joint fitted with the mounting groove, and an opposite end of the connecting member is provided with a connecting arm kit configured to fix with a target vehicle.

3. The external rear-view mirror mounting structure according to claim 2, wherein a side of the connecting member is provided with a first fixing groove, an opposite side of the connecting member is provided with a second fixing groove, a first smooth hole is provided between the first fixing groove and the second fixing groove, a middle of the hemispherical joint is provided with a second smooth hole, a middle of the mounting groove is provided with a third smooth hole, a spherical portion of the hemispherical joint is inserted into the mounting groove, a flat portion of the hemispherical joint is inserted into the second fixing groove, a fastener is inserted from the first fixing groove, sequentially passes through the first smooth hole, the second smooth hole, and the third smooth hole, and finally enters the housing to be in a fixed connection with a corresponding locking member.

4. The external rear-view mirror mounting structure according to claim 3, further comprising a thrust bearing, wherein the thrust bearing is provided between the second fixing groove and the flat portion of the hemispherical joint.

5. The external rear-view mirror mounting structure according to claim 3, wherein an inner side of the housing is provided with a third fixing groove, the third smooth hole is located at a center of the third fixing groove, and the locking member is mounted in the third fixing groove.

6. The external rear-view mirror mounting structure according to claim 3, wherein the fastener is a bolt, and the locking member is a nut.

7. The external rear-view mirror mounting structure according to claim 1, wherein a back side of the housing is provided with a light transmitting groove, and a light strip is provided in an interior of the housing.

8. The external rear-view mirror mounting structure according to claim 2, wherein a back side of the housing is provided with a light transmitting groove, and a light strip is provided in an interior of the housing.

9. The external rear-view mirror mounting structure according to claim 4, wherein the fastener is a bolt, and the locking member is a nut.

10. The external rear-view mirror mounting structure according to claim 5, wherein the fastener is a bolt, and the locking member is a nut.
